(19) United States
(12) Patent Application Publication
(10) Pub. No.: US 2005/0274590 A1
(43) Pub. Date: Dec. 15, 2005

(54) Flight for a conveyor

(75) Inventor: Edwin J Kwiat, Beaver Falls, PA (US)

Correspondence Address: Russell D Orkin;700 Kopper Building, 436 Seventh Avenue, Pittsburg, PA, 15219-1818, US

(73) Assignee: C. U. E., INC., Cranberry Township, PA (US)

(21) Appl. No.: 10/485,189

(22) PCT Filed: Aug. 2, 2002
(86) PCT No.: PCT/US02/24602

§ 371 Date: Jul. 22, 2004

Related U.S. Application Data
(60) Provisional application No. 60/309,840, filed on Aug. 3, 2001.

(51) Int. Cl. B65G 19/08

(52) U.S. Cl. 198/728

(57) ABSTRACT

A flight (5) for use on a flight conveyor has an elongated core (20) and a sound absorbing material (30) secured to the core (20). The sound absorbing material (30) also has high wear resistance. A method of producing such a flight (5) involves securing to the core (20) a sound absorbing material (30).

### BACKGROUND OF THE INVENTION

1. Field of the Invention

This invention relates to a conveyor device and more particularly to a flight conveyor having a flight with a core and a sound absorbing material about the core.

2. Description of Related Art

Flight conveyors employing a central sprocket driven chain with elongated flights extending laterally in opposite directions from spaced sides of the chain are extensively used for the conveying of material. U.S. Pat. Nos. 3,103,275; 4,238,028; and 5,000,310 illustrate general designs for flight conveyors. These types of flight conveyors travel over flat surfaces or decks, wherein the laterally extending flights cooperate with the flat deck to move material therealong. Where such sprocket driven flight conveyors are used on loading machines, the flights are required to move heavy materials, such as large masses of coal, rock and iron along the deck plates. In such structures, the flights travel closely to the deck plates. Typically, the deck plates and the flights are made of steel such that the motion of the flights over the deck plates is inordinately loud.

Flight conveyors are used extensively in coal mines, and recent MSHA standards limit the intensity of noise to which individuals working in coal mines may be exposed. Flight conveyors in mines are a large contributor to such noise.

A design is required that will reduce the noise produced by flight conveyors.

### SUMMARY OF THE INVENTION

One embodiment of the subject invention is directed to a flight adapted for use on the deck of a flight conveyor wherein the flight is moved along the deck by a drive mechanism, said flight comprised of
a) an elongated core having
   1) one end adapted to be attached to the drive mechanism;
   2) a bottom surface; and
   3) a front face for urging material along the deck; and
b) a sound absorbing material secured to the core.

A second embodiment of the subject invention is directed to a method of producing a flight used on the deck of a flight conveyor wherein the flight is moved along the deck by a drive mechanism, wherein the flight has a core and said method comprises the step of securing to the core a sound absorbing material.

### BRIEF DESCRIPTION OF THE DRAWINGS

FIG. 1 illustrates the top view of a pair of flights on a central conveyor chain used for a flight conveyor;

FIG. 2 illustrates a cross section along arrows II-II in FIG. 1;

FIG. 3 illustrates a side view of the pair of flights from FIG. 1;

FIG. 4 illustrates a bottom view of the pair of flights in FIG. 1; and

FIG. 5 illustrates an end view from the right side of the flight in FIG. 1.

### DESCRIPTION OF THE PREFERRED EMBODIMENTS

The subject invention is directed to flights on a flight conveyor which minimize sound produced by the relative motion between the flight and the conveyor deck when the flight conveyor is in operation.

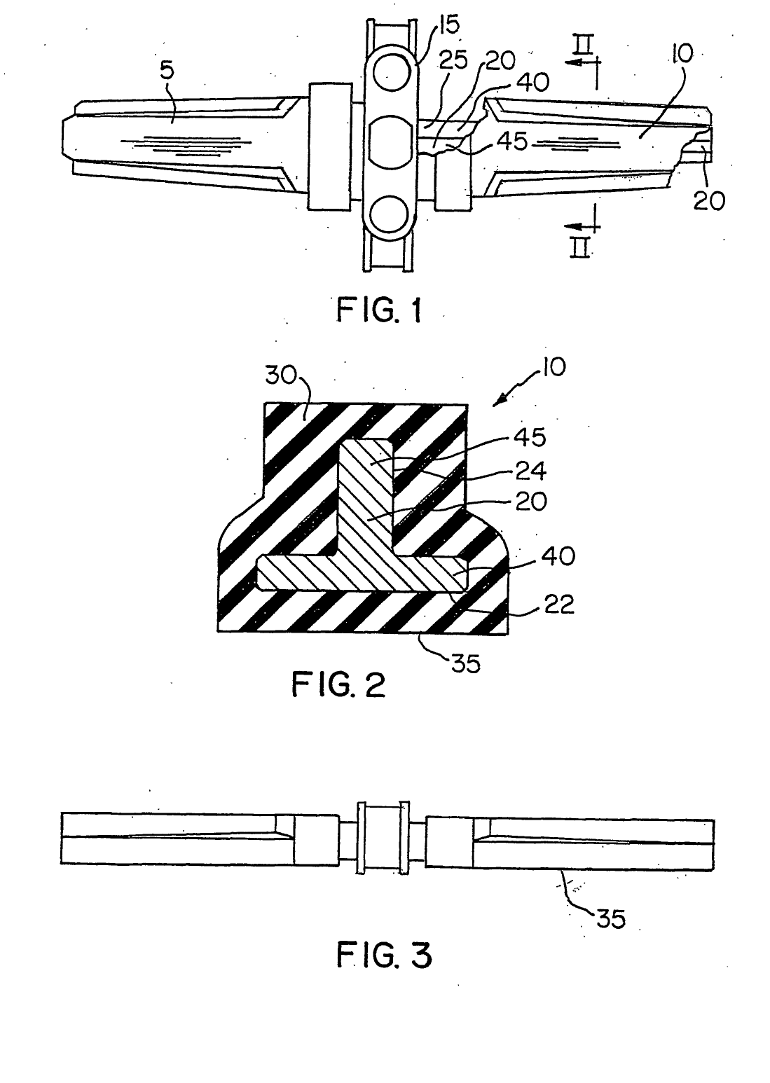

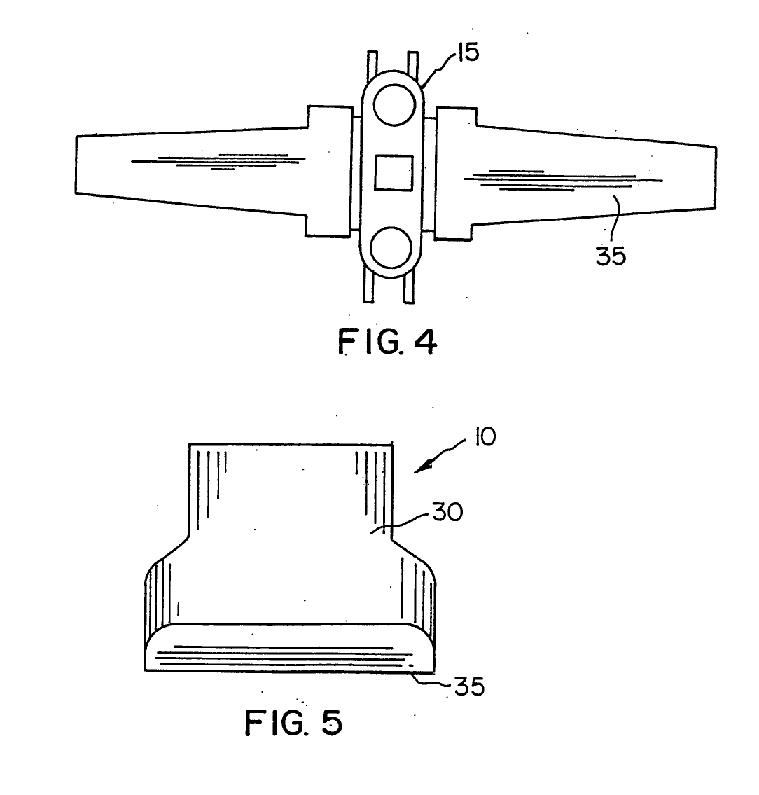

FIG. 1 illustrates a pair of flights 5, 10 extending laterally in opposite directions from spaced sides of a centrally located chain 15. The flights 5, 10 may be connected to the chain 15 in any number of conventional manners, and since it is not a focus of the subject invention, such a connection will not be described in detail. Each of the flights 5, 10 is symmetric to one another, and for that reason, only flight 10 will be discussed with the understanding that flight 5 is symmetric.

Directing attention to flight 10, as mentioned, the flight 10 is adapted for use on the deck of a flight conveyor, wherein the flight is moved along the deck by the chain 15. The flight 10 is comprised of an elongated core 20 (FIG. 2) which extends the length of the flight 10. As illustrated in FIG. 1 the elongated core 20 has one end 25 adapted to be attached to a drive mechanism, such as chain 15. As illustrated in FIG. 2, the core has a bottom surface 22 and a front face 24 for urging material along the conveyor deck (not shown). The bottom surface 35 of the flight 10 is flat.

The primary source of noise on a flight conveyor is produced by the contact between the steel flights and the steel conveyor deck. The inventor has realized it is possible to reduce this noise by providing a layer of sound absorbing material around a flight. Since the primary noise is produced by the contact between the bottom surface of a flight and the conveyor deck, it is possible to provide the sound absorbing material to the bottom surface 22 of the core, thereby providing a layer between the core 20 and the conveyor deck.

While the core 20 may have any variety of different shapes, as illustrated in FIG. 2, the core 20 is generally T-shaped with a horizontal base leg 40 and a vertical leg 45 extending upwardly therefrom. Although the bottom surface 35 of flight 10 contacts the conveyor deck while conveying material, the vertical leg 45 of the core 20 will be in contact with a return deck. For that reason, the vertical leg 45 of the core 20 may also have sound absorbing material secured thereto.

Typically, in the design of flight conveyors, the flight is configured such that material acting against the front face of the flight 10 will not lift the flight 10 away from the conveyor deck. This is accomplished by angling a portion or all of the front face of the flight 10 rearwardly as illustrated in FIG. 2 to force the flight 10 against the deck when displacing material.

Although it may be desirable to secure the sound absorbing material to the entire flight, the end 25 of the core 20, since it must be secured to the drive mechanism 15, should be exposed and preferably the remainder of the core 20 will have sound absorbing material secured thereto.

Directing attention to FIG. 2, the core 20 is T-shaped and the sound absorbing material 30 attached thereto generally follows the contour of the core 20. It is entirely possible for the sound absorbing material to be in the form of a sheet such that, when it is secured to the core 20, it conforms to the predetermined shape of the core 20. However, it should be noted that the subject invention should not be limited to this configuration. In the alternative, it is possible to secure the sound absorbing material to the core to define a completely different shape for the flight defined by the shape of the sound absorbing material.

The sound absorbing material may be a high performance abrasion resistive polyurethane or any other high performance abrasion resistive elastomeric material. Such a material not only provides the sound absorbing properties necessary for the subject invention, but also provides a high level of wear resistance, which may be equally important for flight conveyors subject to a high level of abrasion.

Note that under circumstances where the durability of the material is not required to be high, the sound absorbing material may be material having less durability, such as rubber.

Within the mining industry to promote interchangeability of parts for a given flight conveyor, the flights are a standard size. Therefore, it should be appreciated that the combination of the sound absorbing material 30 when secured to the core 20 should conform to these standard sizes. It is possible in accordance with the subject invention to modify existing flights by removing material from the flight such that the sound absorbing material may be secured to the modified flight, thereby producing a flight having dimensions similar to the standard size of a flight. Under such circumstances, standard flights may be removed from a flight conveyor and modified to accommodate the sound absorbing material, and then reinstalled upon the flight conveyor.

The sound absorbing material 30 may be secured to the core 20 through a molding process. In particular, the sound absorbing material 30 is heated to a liquid state, and introduced into a mold surrounding the core 20, thereby, conforming the sound absorbing material to a predetermined shape around the core 20. It can be appreciated that a cross-section of the core 20 should be non-circular under such circumstances to prevent the molded sound absorbing material from rotating about the core 20. Such molding techniques are known in the industry, and the preparation of the core 20 prior to molding the sound absorbing material around the core 20 is important. However, such preparation is known to those skilled in the art of molding.

As previously mentioned one application of the subject flight conveyor may be for mining operations, and in particular long wall mining operations. The use of sound absorbent material to reduce the noise produced between the flights and the fight deck has applications beyond the mining industry and, therefore, the subject application should not be limited thereto.

In circumstances where it may not be possible to secure the sound absorbing material to the bottom of the flight, and the upper portion of the flight is subject to vibrations, such that the sound may be amplified by the upper portion of a flight, it may be possible to secure the sound absorbing material only to the upper portion of the flight 10 such as vertical leg 45 in FIG. 2, thereby reducing vibration and the subsequent noise while at the same time permitting the bottom of the flight to contact the conveyor deck without the sound absorbing material therebetween.

The subject invention is also directed to a method of producing a flight 10 used on the deck of a flight conveyor, wherein the flight 10 is moved along the deck by a drive mechanism such as a chain 15. The flight has a core 20, and the method is comprised of the step of securing to the core 20 a sound absorbing material 30. Just as before, the sound absorbing material may be polyurethane and more particularly MDI.

The core 20 has a bottom 22 and the method may involve securing a sound absorbing material 30 only to the bottom surface 22 of the core 20. In the alternative, the core 20 may have a top surface as illustrated by vertical leg 45, in FIG. 2, and the sound absorbing material may be secured to the top surface 45 of the core 20.

Core 20 may originally be the flight of a standard flight conveyor, and this core may be reduced in size prior to securing the sound absorbing material, such that the combined core and sound absorbing material provide a flight having the external shape of the conventional flight.

The step of securing the sound absorbing material to the flight may be comprised of molding the material to the core, clamping the material to the core, or mechanically fastening the material to the core.

It is thought the present invention and many of its intended advantages will be understood from the foregoing description and that it will be apparent that various changes may be made in the form construction an arrangement of the parts thereof, without departing from the spirit and scope of the invention, or sacrificing all of its material advantages, the form herein before described merely preferred or exemplary embodiments thereof.

1. A flight adapted for use on the deck of a flight conveyor, wherein the flight is moved along the deck by a drive mechanism, said flight comprised of:
a) an elongated core having
1) one end adapted to be attached to a drive mechanism;
2) a bottom surface; and
3) a front face for urging material along the deck; and
b) a sound absorbing material secured to the core.

2. The flight according to claim 1, wherein the sound absorbing material is also high wear resistance.

3. The flight according to claim 1, wherein the bottom surface of the core has a sound absorbing material secured thereto.

4. The flight according to claim 3, wherein the material secured to the bottom surface of the core provides a flight bottom surface which is flat.

5. The flight according to claim 1, wherein the core is generally T-shaped with a horizontal base leg and a vertical leg extending upwardly therefrom, wherein the vertical leg of the core has sound absorbing material secured thereto.

6. The flight according to claim 1, wherein the front face of the flight is angled rearwardly to force the flight against the deck when displacing material.

7. The flight according to claim 1, wherein the flight is generally T-shaped.

8. The flight according to claim 1, wherein the end of the core adapted to be attached to a drive mechanism is exposed and the remainder of the core has sound absorbing material secured thereto.

9. The flight according to claim 1, wherein the sound absorbing material is secured to the core to define a predetermined shape of the flight.

10. The flight according to claim 1, wherein the sound absorbing material in the form of a sheet and is secured to and conforms to a predetermined core shape.

11. The flight according to claim 1, wherein the sound absorbing material is polyurethane.

12. The flight according to claim 11, wherein the polyurethane is MDI.

13. The flight according to claim 11, wherein the polyurethane has a Shore Durometer Hardness of between 80 and 85.

14. The flight according to claim 1, wherein the combination of the core and material secured thereto has an external shape similar to that of a flight without such material.

15. The flight according to claim 1, wherein the sound absorbing material is secured to the core by molding onto the core.

16. The flight according to claim 1, wherein the sound absorbing material is secured to the core by clamping.

17. The flight according to claim 1, wherein the sound absorbing material is secured to the core by mechanical fastening.

18. The flight according to claim 1, wherein the flight is used for a flight conveyor in a long wall mining operation.

19. A method of producing a flight used on the deck of a flight conveyor wherein the flight is moved along the deck by a drive mechanism, wherein the flight has a core and said method comprising the step of securing to the core a sound absorbing material.

20. The method according to claim 19, wherein the sound absorbing material is polyurethane.

21. The method according to claim 19, wherein the core has a bottom and the sound absorbing material is secured to the bottom of the core.

22. The method according to claim 19, wherein the core has a top surface and the sound absorbing material is secured to the top of the core.

23. The method according to claim 19, wherein the core has an end surface adapted to be secured to a drive mechanism on a flight conveyor and the sound absorbing material is secured to the remainder of the core.

24. The method according to claim 19, wherein the core is reduced in size prior to securing the sound absorbing material such that the combined core and sound absorbing material provide a flight having the external shape of a conventional flight.

25. The method according to claim 19, wherein the step of securing the sound absorbing material is comprised of molding the material to the core.

26. The method according to claim 18, wherein the step of securing the sound absorbing material is comprised of clamping the material to the core.

27. The method according to claim 18, wherein the step of securing the sound absorbing material is comprised of mechanically fastening the material to the core.
